(19) United States
(12) Patent Application Publication
(10) Pub. No.: US 2013/0122327 A1
(43) Pub. Date: May 16, 2013

(54) APPARATUS AND METHOD FOR IMPARTING SELECTED TOPOGRAPHIES TO ALUMINUM SHEET METAL

(71) Applicants: Shen Sheu, Murrysville, PA (US); Julie A. Wise, Natrona Heights, PA (US); Tom J. Kasun, Export, PA (US); Neville C. Whittle, Irwin, PA (US); June M. Epp, Pittsburgh, PA (US); David E. Coleman, Murrysville, PA (US); Norman J. Panseri, Irwin, PA (US); Salvador A. Marcilla Gomis, Alicante (ES); Patricia A. Stewart, Pittsburgh, PA (US)

(72) Inventors: Shen Sheu, Murrysville, PA (US); Julie A. Wise, Natrona Heights, PA (US); Tom J. Kasun, Export, PA (US); Neville C. Whittle, Irwin, PA (US); June M. Epp, Pittsburgh, PA (US); David E. Coleman, Murrysville, PA (US); Norman J. Panseri, Irwin, PA (US); Salvador A. Marcilla Gomis, Alicante (ES); Patricia A. Stewart, Pittsburgh, PA (US)

(21) Appl. No.: 13/673,468

(22) Filed: Nov. 9, 2012

Related U.S. Application Data
(60) Provisional application No. 61/558,504, filed on Nov. 11, 2011.

(51) Int. Cl. B24C 1/10; B32B 33/00

(52) U.S. Cl. CPC B24C 1/10; B32B 33/00
USPC 428/687; 72/53

(57) ABSTRACT

A method for surface treating work rolls to produce isotropic textured aluminum sheet features shot-peening the surface of the working rolls that produce the sheet. The media may be steel balls, such as ball bearings or other media, such as glass or ceramic balls, depending upon the optical properties desired for the aluminum sheet, e.g., in terms of diffuseness or brightness of reflection. The various parameters of shot-peening can be varied to accommodate given properties of the roll, such as hardness and existing surface texture to achieve a given desired surface texture. A sheet surface with target properties and the work roll processing needed to produce it may be generated by computer modeling.

### CROSS REFERENCE TO RELATED APPLICATIONS

The present application claims the benefit of U.S. Provisional Application No. 61/558,504 entitled, Apparatus and Method for Imparting Selected Topographies to Aluminum Sheet Metal, filed Nov. 11, 2011, the disclosure of which is incorporated herein by reference in its entirety for all purposes.

### FIELD

The present invention relates to rolled sheet metal and surfacing thereof, and more particularly, to methods and apparatus for producing specific surface textures having associated frictional and optical characteristics, such as an isotropic surface on aluminum sheet.

### BACKGROUND

Currently, aluminum sheet producers often use a temper rolling mill or a cold rolling mill to produce sheet of a desired thickness, width and surface. The surface of the cylindrical rolls (work rolls) through which the sheet aluminum passes may be prepared for a rolling operation by grinding with an abrasive grinding wheel or belt. Grinding leaves the roll surface with a directional appearance due to grinding marks (grain), which are then transferred/imparted to a sheet that is rolled by the ground work roll. The directional appearance of sheet rolled by ground work rolls is visible and frequently can be seen through painted coatings applied to the sheet material or to products made from the sheet material, such as an automobile body panel.

Embossing mills are also used to impart a given surface topography on sheet metal, e.g., to produce non-directional topographies. Processing sheet in an embossing mill is conducted after the rolling process and after the sheet has been reduced in thickness to target dimensions that approximate the final dimensions of the sheet. Embossing mills are intended to impart surface texture only, as opposed to having a substantial sizing effect on the sheet, and therefore operate on sheet that has already been rolled by the work rolls of a rolling mill. Embossing sheet in an embossing mill represents additional steps beyond rolling, requiring additional apparatus, material handling and managing a greater variety of roll types compared to normal rolling mills.

### SUMMARY

The present disclosure relates to a method for surfacing a work roll for rolling aluminum sheet. More specifically in accordance with one approach, the surface of the work roll is shot-peened using media which includes spherical media.

In one approach, the spherical media used for shot-peening includes steel balls.

In one approach, the steel balls are ball bearings of grade 1000.

In one approach, the ball bearings have a diameter ≦0.125 inches and a hardness Rc≧60.

In one approach, the step of shot-peening is preceded by the step of pre-grinding the work roll, the step of pre-grinding imparting an initial surface texture on the work roll.

In one approach, the media includes abrasive grit.

In one approach, the media includes glass balls.

In one approach, the media includes ceramic balls.

The disclosed subject matter also relates to a method for rolling aluminum sheet. In one approach, a work roll utilized for rolling aluminum sheet is surfaced by shot-peening using spherical media. The surfaced work roll is installed in a rolling mill and utilized to roll aluminum sheet to reduce the aluminum sheet from a given initial thickness to a selected thickness, while simultaneously imparting a texture from the work roll onto the surface of the aluminum.

In one approach, the spherical media used for shot-peening includes steel balls and wherein the reduction in thickness of the aluminum sheet is ≧10% of the initial thickness.

In one approach, the reduction in thickness of the aluminum sheet is in the range of 10 to 45%.

In one approach, the work roll is pre-ground prior to surfacing, the step of pre-grinding imparting a first surface texture on the roll, the step of surfacing imparting a second surface texture on the roll at least partially over-struck on the first surface texture and incompletely eradicating the first surface texture, such that a composite surface texture is formed.

In one approach, the step of shot-peening may be conducted at an adjustable pressure to control media velocity and momentum when the media impacts the roll, the media and the velocity thereof corresponding to a media impression depth, width and shape on the surface of the roll and adjusting the pressure at which shot-peening is conducted to achieve a given surface texture.

In one approach, the dwell time of shot-peening of the roll surface is adjusted to control the number of impacts of the media on the surface of the roll and the consequential % coverage of media impressions on the surface of the roll to achieve a given surface texture.

In one approach, the surface texture of the roll has corresponding optical characteristics relating to the interaction of the surface with light impinging on the surface of the roll and the directions in which light impinging on the roll is reflected from the surface and giving rise to the diffusiveness/specularity of the surface.

In one approach, a plurality of sheets of aluminum are rolled, the sheets differing in width and at least one variation in width being rolling a narrower sheet followed by rolling a wider sheet.

In one approach, the adjustment of the velocity of the media is determined at least partially based upon the hardness of the roll.

In one approach, the adjustment of the velocity of the media is determined at least partially by the initial surface texture of the roll prior to shot-peening.

The disclosed subject matter also relates to a method for generating aluminum sheet having desired optical properties by accumulating a data file which associates a plurality of given surface profiles with corresponding optical properties of each surface profile, including light scatter, length scale and surfacing treatment parameters utilized to realize each of the plurality of surfaces; prescribing a virtual surface by specifying target optical properties; modeling the virtual surface by retrieving data pertaining to at least one given surface profile with the most similar optical properties as the target optical properties; comparing the target optical properties to the optical properties of the at least one given surface profile; in the event that the comparison does not indicate identity, then retrieving data pertaining to another surface profile in the data file that has optical properties that are similar to the target properties but are at variance to the target properties in an opposite respect relative to how the optical properties of the at least one given surface profile differ from the target properties; sampling from the optical properties of the at least one given surface profile and from the another surface profile in proportion to the magnitude of their respective differences from the target properties to arrive at corrected optical properties of a corrected virtual surface and recording the composited sampled composition contributions of the at least one given surface profile and the another surface profile; comparing the optical properties of the corrected virtual surface to the target optical properties to ascertain if there has been a reduction in the differences there between; and if so, then repeating the steps of retrieving, sampling and comparing until no improvement is discerned, whereupon the best virtual surface relative to the target has been ascertained; ascertaining the surfacing treatment parameters utilized to realize each of the plurality of surfaces by compositing such parameters in proportion to the contribution of optical properties of each surface profile composited in the best virtual surface thereby defining best surfacing treatment parameters; conducting surfacing of a roll in accordance with the best surfacing treatment parameters; and rolling the aluminum sheet with the roll surfaced above.

In one approach, a modeling method for generating aluminum sheet having desired optical properties is conducted by a non-linear least squares optimization algorithm.

The disclosed subject matter also relates to a work roll having a shot-peened surface for rolling sheet metal, the surface having been shot-peened using media which includes spherical media.

The disclosed subject matter also relates to a sheet of aluminum metal having a surface texture imparted by a work roll having a surface shot-peened using media which includes spherical media.

### BRIEF DESCRIPTION OF THE DRAWINGS

For a more complete understanding of the present invention, reference is made to the following detailed description of exemplary embodiments considered in conjunction with the accompanying drawings.

FIGS. 1a and 1b are a plan view and a perspective (3D) view graphical mappings, respectively, of surface morphology of a sample surface of a working roll produced by EDT texturing and as measured by optical profilometry.

FIG. 2 is a diagrammatic view of an apparatus for surfacing a work roll in accordance with an embodiment of the present disclosure.

FIG. 3a is a plan view graphical mapping of surface morphology of a sample surface of a working roll produced by a process in accordance with an embodiment of the present disclosure and as measured by optical profilometry. FIG. 3b is an enlarged view of a fragment of FIG. 3a, and FIGS. 3c and 3d are perspective graphical mappings of the surfaces shown in FIGS. 3a and 3b, respectively, as measured by optical profilometry.

FIGS. 4a and 4b are plan view and perspective (3D) view graphical mappings, respectively, of surface morphology of a sample surface of a working roll produced by a process in accordance with an embodiment of the present disclosure, as measured by optical profilometry.

FIG. 5a is a plan view graphical mapping of surface morphology of a sample of rolled aluminum sheet in accordance with an embodiment of the present disclosure and rolled by a working roll produced by a process in accordance with an embodiment of the present disclosure, as measured by optical profilometry. FIG. 5b is an enlarged view of a fragment of FIG. 5a, and FIGS. 5c and 5d are perspective graphical mappings of the surfaces shown in FIGS. 5a and 5b, respectively, as measured by optical profilometry.

FIGS. 6a, 6b and 6c are plan view graphical mappings of surface morphology of three samples of rolled aluminum sheet in accordance with an embodiment of the present disclosure and rolled by a working roll produced by a process in accordance with an embodiment of the present disclosure at 10% reduction, 20% reduction and 40% reduction, respectively, as measured by optical profilometry. FIGS. 6d, 6e, and 6f are perspective graphical mappings of the surfaces shown in FIGS. 6a, 6b and 6c, respectively, as measured by optical profilometry.

FIGS. 7a and 7b are photographs of working rolls that have been surfaced in accordance with an embodiment of the present invention and FIGS. 7c and 7d are enlarged photographs of fragments of FIGS. 7a and 7b, respectively.

FIG. 8 is a graph of the influence of surface texture on the coefficient of friction.

FIG. 9 is a schematic diagram of a process for developing a surface texture in accordance with an exemplary embodiment of the present disclosure.

### DETAILED DESCRIPTION OF EXEMPLARY EMBODIMENTS

An aspect of the present disclosure is the recognition that for many applications of sheet metal, it is desirable to have a uniform, non-directional surface finish, i.e., a surface which appears isotropic and reflects light diffusely. Further, the present disclosure recognizes that in addition to appearance effects, the directionally oriented roughness of a sheet surface rolled by ground work rolls influences forming processes that may be used to form the sheet metal into a shaped product, such as an automobile panel, e.g., attributable to variations in frictional interaction between the forming tool and the sheet stock due to directionally oriented grain/grinding patterns in the surface of the metal sheet that were imparted by the work roll. The present disclosure also recognizes that a more isotropic surface is beneficial in conducting some forming processes that operate on aluminum sheet.

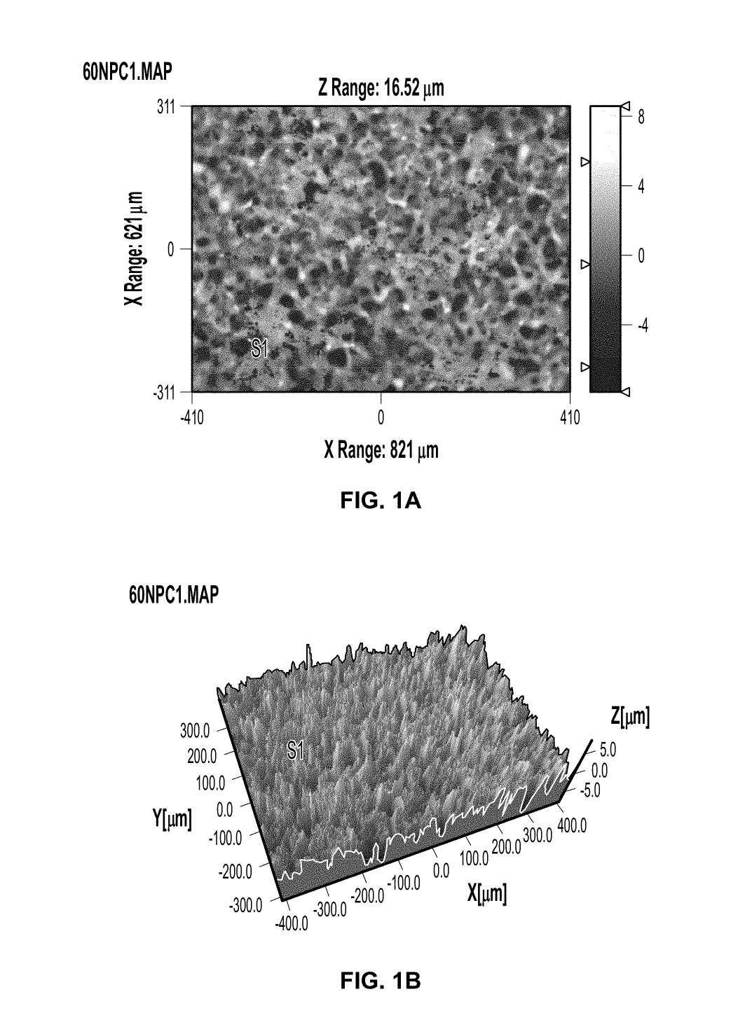

One method for producing a more isotropic surface on a work roll that is used to roll aluminum sheet metal (primarily for automotive sheet) is to surface the roll with an electric discharge texturing (EDT) machine. An EDT texturing head with multiple electrodes can be placed near the roll surface to generate an electric discharge/spark/arc from each electrode to the roll surface, locally melting the roll surface at each spark location and inducing the molten steel to form small pools of molten metal within associated craters. Operation of an EDT machine along the surface of a rotating roll produces an improved isotropic surface, but one which features numerous microscopic craters in the range of up to 100 μm in diameter and with rim heights of up to 15˜20 μm (FIG. 1).

Applicants have recognized that the rims of the microscopic craters formed by the EDT process may be brittle, such that when the EDT textured rolls are used in a rolling mill, high contact pressure, e.g., up to 200 ksi, between the work roll, the sheet and/or the backup roll, can wear down the isotropic texture and produce debris, which is deposited on the sheet surface, on the mill and in the lubricant.

FIG. 1 shows a sample surface morphology of a surface S1 of an EDT treated working roll used for the rolling of aluminum sheet. As can be appreciated, the surface morphology could be characterized as covered with numerous sharp peaks and valleys 5.0 μm in magnitude relative to a reference plane.

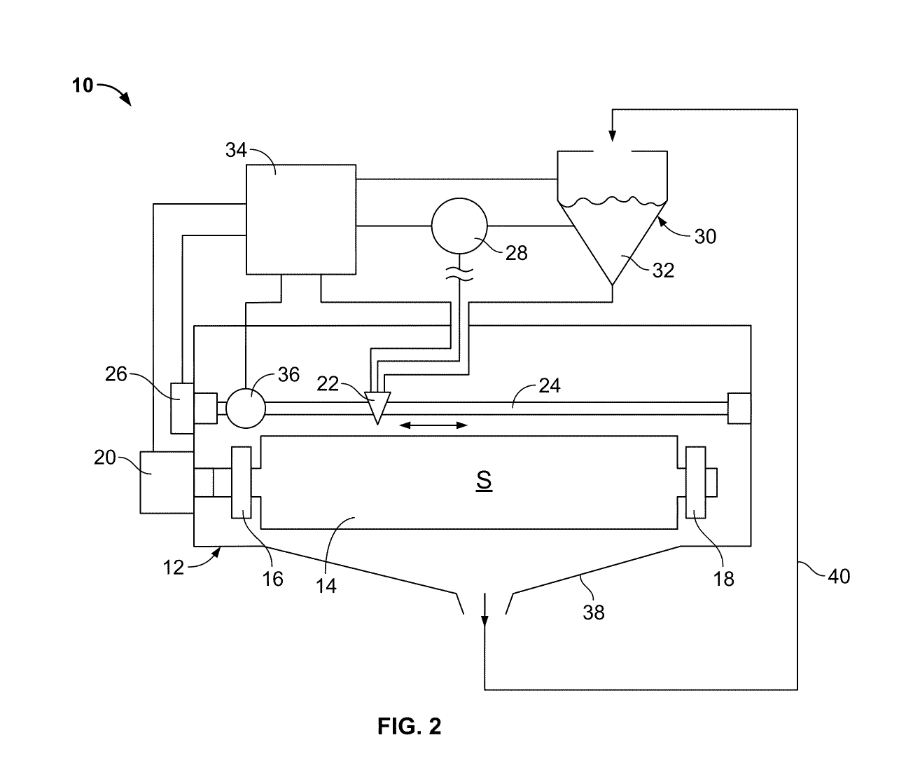

FIG. 2 shows a roll treating apparatus 10 having a cabinet 12 for containing a working roll 14. The working roll 14 may be supported on bearings 16, 18 to enable turning, e.g., by a motor 20 coupled to the working roll 14. The cabinet 12 also houses a shot/ball peening nozzle 22 which may be mounted on a gantry 24 that allows the nozzle 22 to be selectively moved and positioned, e.g., by the action of a motor 26 turning a screw drive or actuating a chain, rack, cable drive, or actuation via a motor-driven friction wheel drive associated with the nozzle 22. The nozzle 22 is fed by a compressor 28 and a media hopper 30. The nozzle 22 mixes compressed gas, e.g., air, from the compressor 28 and media 32 from the hopper 30, propelling and directing the media 30 against the outer surface S of the roll 14. The media may be in the form of steel, glass or ceramic balls, abrasive grit or other blasting/shot peening media, as described further below. A computer 34 may be used to programmatically control: the position of the nozzle 22 by controlling the motor 26, the rotation of the roll by controlling motor 20, the operation of the compressor 28 and the rate of dispensing media 32 from the hopper 30. A vision system 36 may be housed within the cabinet 12 to provide a view of the state of the surface S in order to ascertain whether a given target surface texture has been achieved through operation of the action of the roll treating apparatus 10. This vision system may be attached to the nozzle 22 or independently moveable on the gantry 24, may include magnification and a shield to protect input aperture and lens from impact from the media 32. Media 32 that has been projected through the nozzle 22 may be dispensed through a funnel portion 38 of the cabinet 12 to a recycling line 40 that returns the media 32 to the hopper 30, e.g., via a screw feed or a under the influence of compressed air, a blower or suction. The cabinet 12 may be provided with a door(not shown) and sight glass (not shown) to facilitate transfer of the roll 14 in and out of the cabinet 12 and to monitor the operation of roll treating apparatus 10. The nozzle 22 and compressor 28 may be of a commercial type to achieve the target peeing intensities to create the desired surface topography.

Alternatively, the nozzle 22 may be hand-held, as in conventional shot-peening apparatus. The compressor 28 and the nozzle 22 may be changed to obtain the target peening intensity pressure output, i.e., either manually or under computer control, to regulate the velocity of media 32 projected from the nozzle 22 to accommodate different types of media 32, as well as to accommodate various operating conditions, such a roll 14 hardness, initial surface texture and the type of texture desired for surface S, e.g., attributable to the depth and circumference of dimples made in the surface of the roll by a given media 32, such as steel balls/shot. The number of impacts and the dimensions of the impressions made by the media on the roll surface area relative to the total area can be described as, “% coverage” and can be adjusted by the compressor output setting, media flow rate and traverse speed of the nozzle 22 relative to the roll 14, as the nozzle 22 passes over the roll 14 and/or as the roll 14 is spun by motor 20. The control of the shot-peening process can be automatic or manual. For example, a person can manually hold, position and move the nozzle 22 and or the roll 14, as in traditional shot-peening operations wherein the person is equipped with protective gear and partially or fully enters into a cabinet containing the work piece. Visual or microscopic inspection of the roll may be conducted to verify suitable operation or to adjust the apparatus 10 and to verify an acceptably surfaced roll 14 at the completion of the peening/blasting operation.

As another alternative, the nozzle 22 may be contained within a portable, open-sided vessel (not shown) that presses against the surface S forming a moveable peening chamber that captures and redirects spent media back to a storage reservoir like hopper 30. This peening chamber may be positioned and moved manually or mechanically, such as, by a motor-driven feed mechanism like gantry 24 and optionally under the control of a computer 34.

The apparatus and methods of the present disclosure may be used to surface a working roll that imparts a given desired surface to sheet as it is rolled to size, e.g., to provide a sheet with an isotropically diffuse or bright appearance, eliminating the need to emboss or use a temper pass to create a textured sheet. In this context, “bright” refers to specular and “diffuse” refers to a non-specular appearance. The surface textures can be varied to achieve a given desired appearance and forming functionality associated with frictional properties by the appropriate choice of media and operating parameters.

In accordance with the present disclosure, the desired texture is applied to a work roll surface e.g. S, by a peening/blasting process that propels the selected media at the work roll surface S through a nozzle 22 by air pressure. The pressure, processing time per unit area, e.g., as a function of work roll 14 rotation speed and nozzle 22 traverse speed, nozzle 22 configuration and media 32 type are controlled to produce the desired work roll texture, which is effected by media 32 size, shape, density, hardness, velocity and resultant dimple or indentation depth, width and shape and % coverage of dimples on the treated surface area S. In accordance with some embodiments of the present disclosure, the media 32 chosen include high quality, precision steel ball bearings or shot, beads (glass, ceramic), or bead/grit mixtures. The grits can be aluminum oxide, silicon carbide or other grit types.

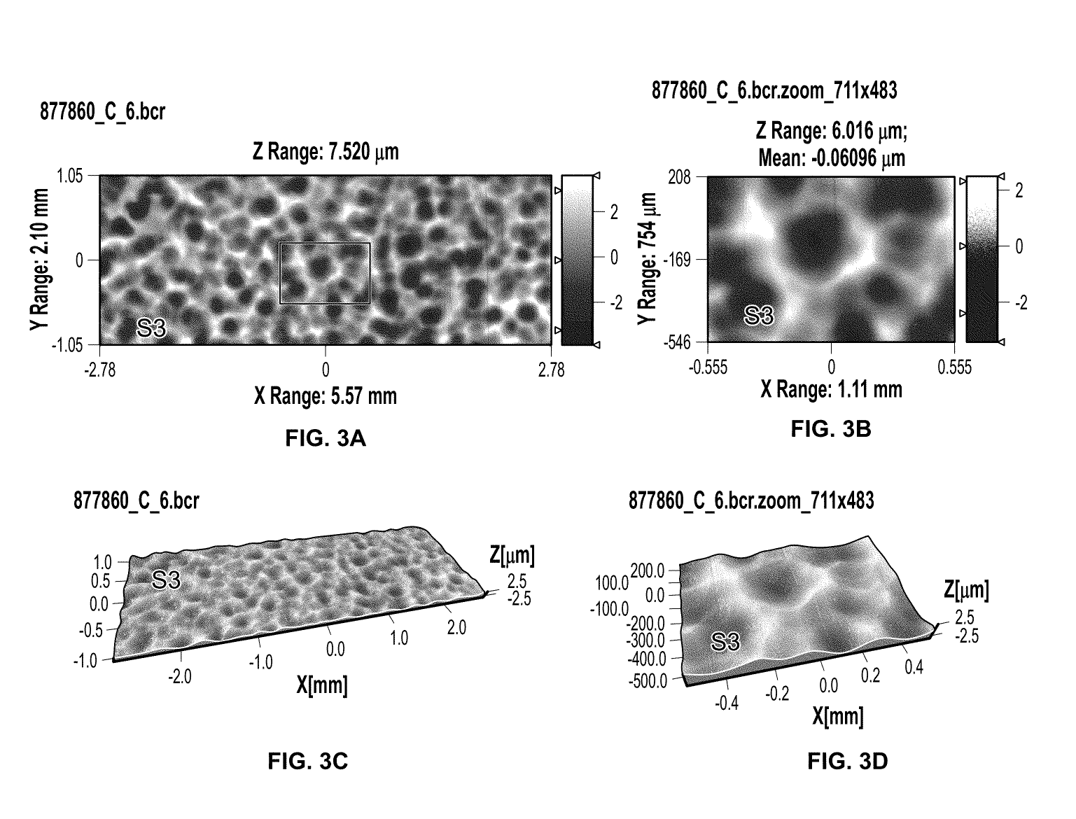

FIGS. 3a-3d show graphical mappings of surface morphology as measured by optical profilometry of a work roll surface that has been surfaced in accordance with an embodiment of the present disclosure. The surface S₃ shown in FIGS. 3a-3d has been peened with steel ball bearings of grade 1000 with a diameter of ≦0.125″ and a hardness of Rc≧60. Grade 1000 has 0.001″ spherical and ÷0.005″ size tolerances. The stand-off distance of the nozzle 22 from the roll 14 may be about 1 inch to about 12 inches, with a stand-off of about 5 inches being preferred for some applications. As can be appreciated, the use of ball bearings as peening media results in uniformly shaped dimples on the work roll surface and the absence of the sharp, raised lips that are typical of EDT textures. The generally smooth undulations in the surface S₃ of the work roll have a magnitude typically within the range of +/−3 to 6 μm, however, dimples of any desired magnitude, e.g., in excess of 10 μm or less than 3 μm, may be achieved, as desired. A typical EDT surface has a greater number of severe surface variations. A work roll shot-peened with ball bearings, as described above, can be used to produce bright sheet with an isotropic appearance, depending upon the starting background roll surface. While grade 1000 ball bearings were described above, other types of precision balls may be used, depending upon roll hardness.

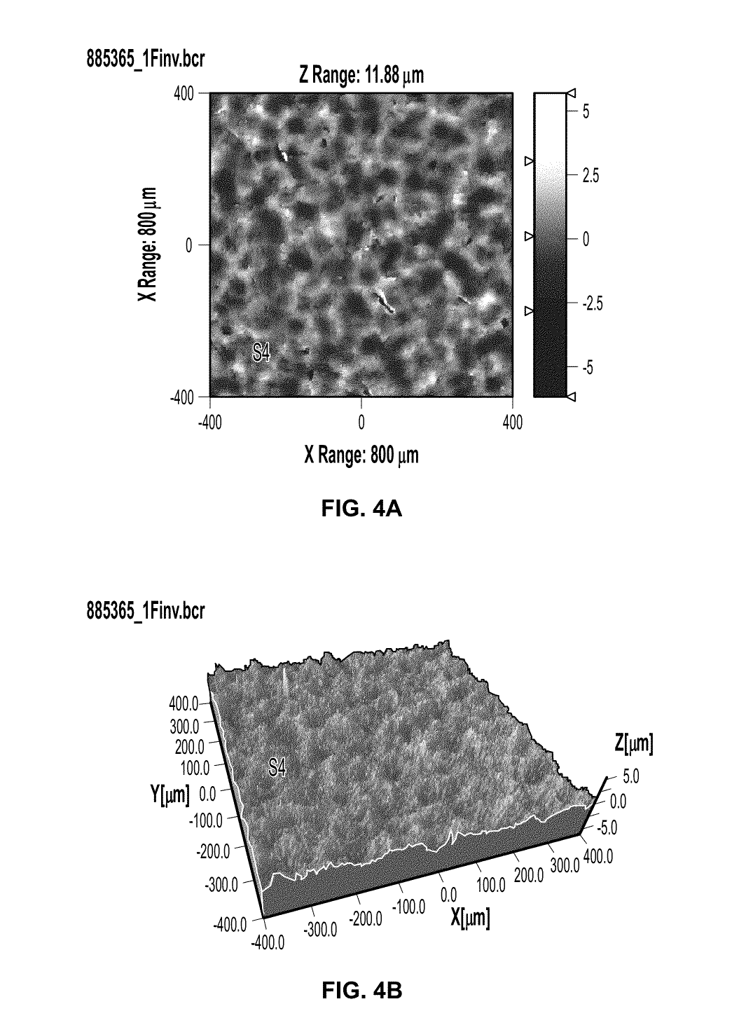

FIGS. 4a and 4b show a work roll surface S₄ produced in accordance with another embodiment of the present disclosure. More particularly, FIG. 4a is a plan view as measured by optical profilometry of the topology of a work roll surface that has been peened with aluminum oxide grit mixture (2:3 ration of 120:180 grit) followed by glass beads of grade AC (60-120 mesh). The aluminum oxide grit blasting was carried out in a manner to remove the pre-grind roll pattern (as ascertained by visual evaluation), followed by blasting with the glass beads to achieve a desired diffuse surface appearance. FIG. 4b is a perspective (3D) graphical mapping of surface morphology of the surface S₄ shown in FIG. 4a, as measured by optical profilometry. As can be appreciated from FIGS. 4a and 4b, the use of glass beads results in a surface S₄ having fewer severe peaks than an EDT surface and the magnitude of surface variations is smaller than an EDT surface. FIG. 4b shows surface variations in the approximate range of +/−2.0 μm. Accordingly, one could fairly characterize the resultant surface S₄ as smoother than an EDT surface, but still having a micro-roughness which may be used to impart a diffuse isotropic surface appearance to an aluminum sheet that is rolled by a working roll having this type of surface.

In accordance with the present disclosure, surface treatment of a work roll by peening results in a surface which is less brittle than a work roll surface treated by the EDT process. As a result, the work roll surface (texture) lasts longer, can sustain higher surface loading pressures and creates less debris when used in rolling operations. In accordance with an embodiment of the present disclosure, where spherical media, such as ball bearings or glass beads, are used to surface the work roll, the gently undulating surface texture produced on the work roll provides advantages in the rolling process to produce an isotropic surface. Compared to normal, ground work rolls or EDT surfaced work rolls, the gentle undulations promote lower friction between the sheet and the working rolls, enabling higher reductions in sheet thickness to be conducted before lubricant or roll surface failure. The texture of a work roll surfaced in accordance with the present disclosure does not wear at the same rate as a typical ground work roll or an EDT surfaced roll. Experiments have shown that in a work roll-driven mill, the textures imparted to the roll by the methods of the present disclosure last 5 to 6 times longer than normally ground roll surfaces and that higher reductions are possible than those taken by EDT working rolls before exceeding mill horsepower limitations and experiencing lubricant failure. A roll surface morphology generated in accordance with an embodiment of the present disclosure can withstand greater than a 10% thickness reduction ratio to produce the desired textured sheet, e.g., up to 50%. This is in contrast to EDT surfaced working rolls which are typically operated in a range of about 8% to 10% reduction. Taking higher reductions can potentially allow elimination of an otherwise necessary pass(es) through the rolling mill to achieve the desired thickness.

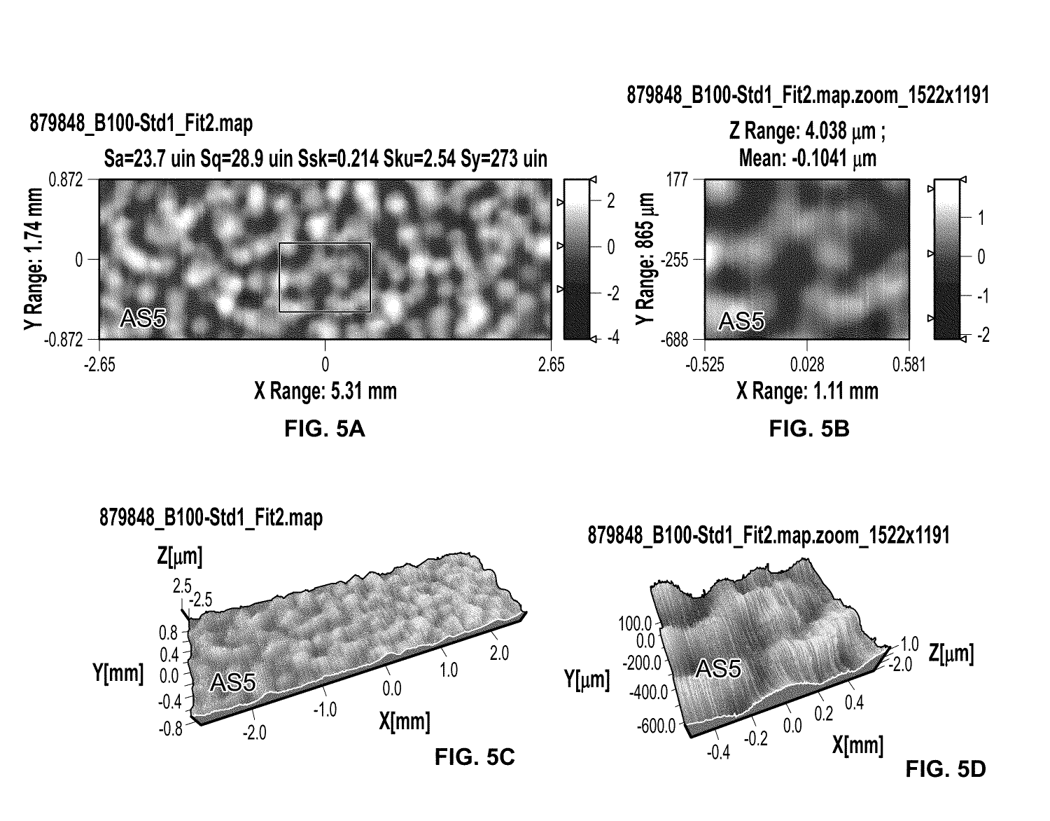

FIG. 5a shows a sample surface AS₅ of a rolled aluminum sheet in accordance with the present disclosure and rolled by a working roll 14 with a roll surface, such as the roll surface S₃ illustrated in FIGS. 3a-3d, produced by a process in accordance with an embodiment of the present disclosure. FIG. 5b is enlarged view of the surface shown in FIG. 5a, both being rendered by optical profilometry. FIGS. 5c and 5d are perspective (3D) graphical mappings of the sample imaged in FIGS. 5a and 5b as measured by optical profilometry. The sheet produced as illustrated in FIGS. 5a-5d were produced by shot-peening with precision steel ball bearings. As illustrated and in general, the macro-texture, e.g., peened dimples, imparted to sheet metal by the working rolls during rolling is the inverse of the texture on the work roll. However, both macro and micro features affect the final level of surface brightness, i.e., the final level of specular reflection, of the sheet.

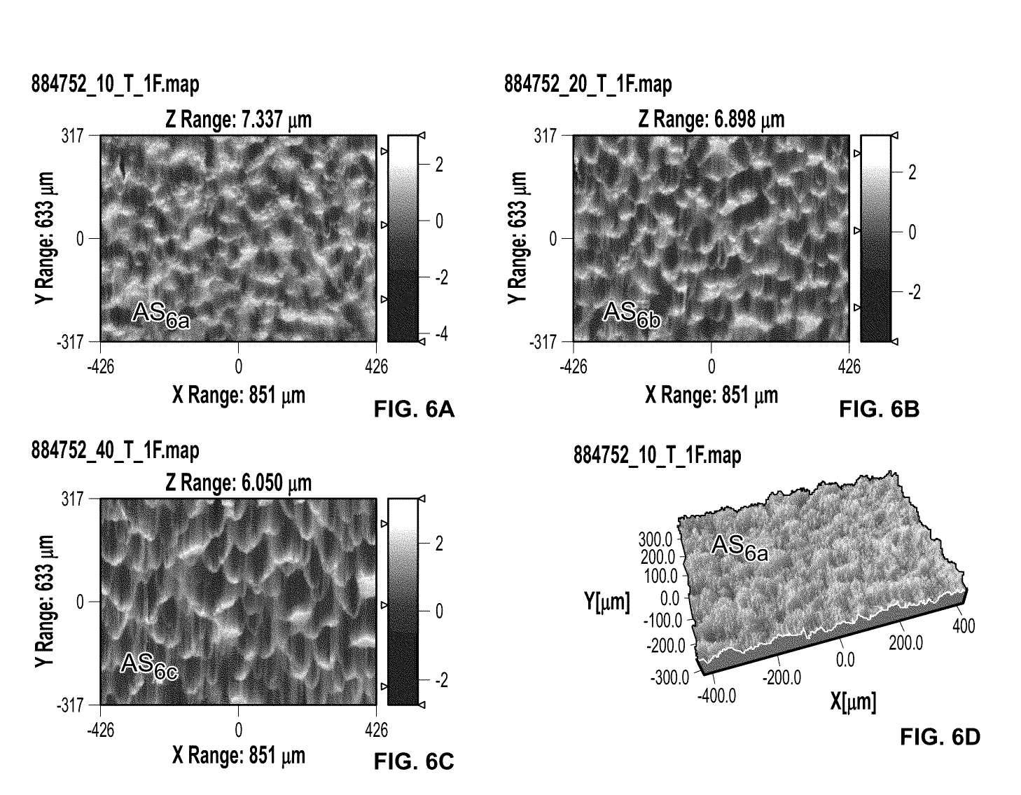

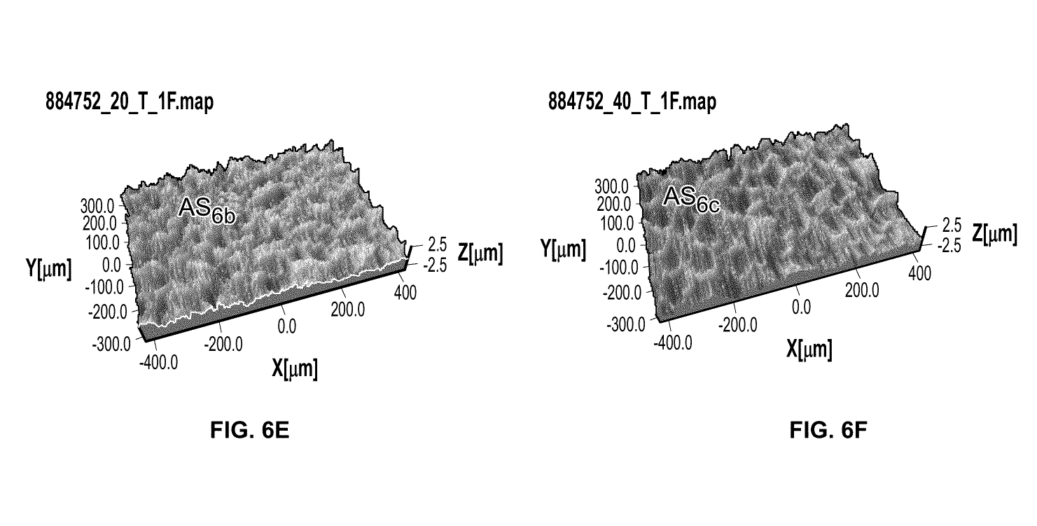

FIGS. 6a, 6b and 6c show plan view graphical mappings of surface morphology of three surface samples AS₆ₐ, AS_{6b} and AS_{6c} of rolled aluminum sheet in accordance with an embodiment of the present disclosure and rolled by a working roll produced by a process in accordance with an embodiment of the present disclosure at 10% reduction, 20% reduction and 40% reduction, respectively, and as measured by optical profilometry. The working roll used to roll these samples was surfaced by shot-peening with aluminum oxide grit followed by shot-peening with glass beads, as described above relative to FIGS. 4a and 4b. FIGS. 6d, 6e, and 6f are perspective graphical mappings of the surfaces shown in FIGS. 6a, 6b and 6c, respectively, as measured by optical profilometry.

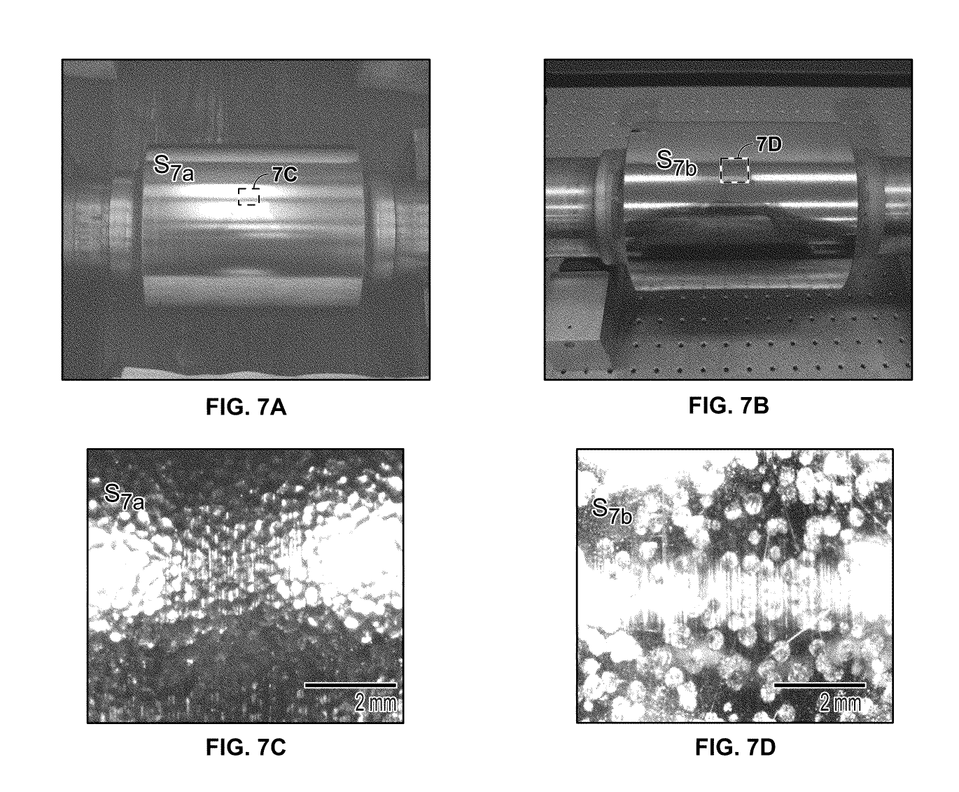

FIGS. 7a and 7b are photographs of working rolls that have been surfaced in accordance with an embodiment of the present invention. FIGS. 7c and 7d are enlarged photographs of fragments of FIGS. 7a and 7b, respectively. The roll shown in FIGS. 7a and 7c were shot-peened with class 1000 steel balls of 1.6 mm in diameter. The roll was shot-peened under conditions that produced 100% coverage of the surface S₇ₐ of the roll with dimples. The roll shown in FIGS. 7b and 7d were shot-peened with class 1000 steel balls of 2.36 mm in diameter. The roll was shot-peened under conditions that produced 50% coverage of the surface S_{7b} of the roll with dimples.

In accordance with an embodiment of the present disclosure, sheet can be produced through normal rolling production schedules, eliminating the need to emboss or use a temper pass on the rolling mill. The resultant work roll surface textures do not wear as fast as EDT produced and normal ground roll surfaces. As a result, roll life exceeds 5 to 6 times that of normal rolls. On a work roll-driven mill, production is not limited to wide-to-narrow production schedules since the texture does not develop banding due to wear. As noted above, the sheet produced by a work roll surface shot-peened with, e.g., ball bearings, generates less debris than an EDT surfaced or normal ground surface, resulting in cleaner lubricant and sheet during rolling. The resultant sheet is isotropic in appearance.

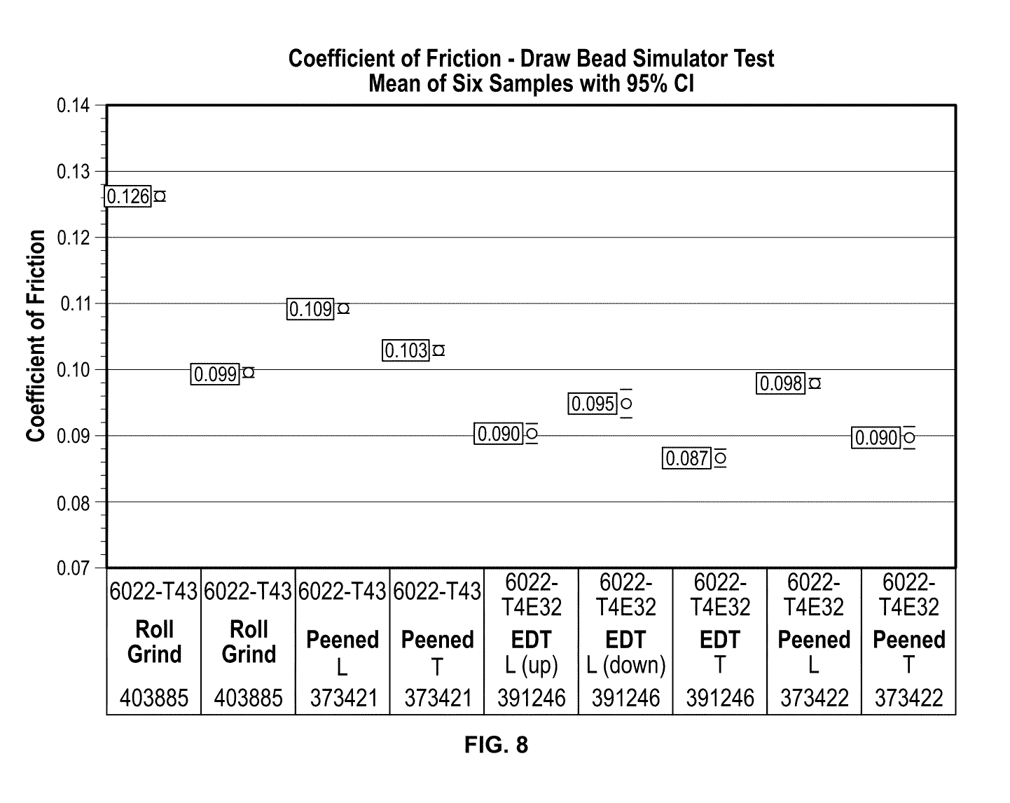

FIG. 8 shows the directionally dependent coefficient of friction during a forming operation of various surfaces when forming is performed in longitudinal (L) and transverse (T) directions. As to the sample 6022-T43, the peened surface showed a reduction in friction on average and a smaller variation in friction dependent upon the direction of forming. Isotropic frictional interaction with forming tools, such as those used in drawing and ironing may represent an improvement in forming performance, e.g., producing more uniform drawing and extended drawing limits.

In accordance with the present disclosure, the initial surface finish requirements for the work roll before peening, e.g., with ball bearings, depends on the final sheet appearance requirement, e.g., highly specular or somewhat specular. The background roughness is preferred to be <1 μin if a highly specular isotropic surface is desired. If a less specular surface is required, the intial work roll grind can be any desired grind up to 50 μin. The amount of pre-grind desired impacts the final cost of the entire process since it is generally more expensive to produce a surface finish <1 μgin roughness. The initial surface finish requirements for the work roll before peening with glass beads or other media to produce a diffuse surface is preferred to be <15 μin or a roughness such that the roll grind pattern is not visible on the peened work roll after processing. The removal of the background roll grind during glass bead peening will be dependent upon the peening processing parameters chosen to produce the diffuse finish. The present disclosure is further illustrated by the following examples.

### EXAMPLE 1

FIGS. 3a-d, 7a and 7c show images of an exemplary surface S₃, S₇ₐ of a working roll made in accordance with an exemplary embodiment of the present disclosure. To generate the surface shown, a background roll topography is created with standard grinding processes (pre-grind) of about <5 μin roughness. A series of dimples ranging in diameter from 200 to 300 μm are produced on the roll surface by shot-peening with class 1000 steel balls of 1.6 mm in diameter and hardness Rc≧60. The balls are propelled against the surface of a roll having a hardness of about 58 to 62 Rc, at a velocity causing a dimple diameter of about 200 μm to 400 μm and a dimple depth of about 0.5 μm to about 4 μm. Dimple diameter and depth are affected by processing conditions (ball velocity) and are dependent upon the initial work roll hardness. In this example, about 100% of the surface area is covered by dimples, as measured by visual inspection, but coverage can range from about 10% to about 250%, depending upon the desired surface appearance finish. The % coverage measured can vary depending upon the method of measuring. Optical methods tend to over-estimate coverage when compared to physical measurement from topographical images.

The benefits experienced with use of these rolls in breakdown rolling include: pass elimination (1 pass eliminated in cold rolling, 3 passes eliminated in hot rolling); the ability to roll wide to narrow; increased roll life; less roll coating developed in hot rolling due to reduced material transfer; and reduced debris generation in cold rolling.

### EXAMPLE 2

In accordance with another exemplary embodiment of the present disclosure, a diffuse surface work roll may be made by peening a working roll that is pre-ground at <5 microinch roughness The media may be glass bead, other “ceramic” beads of grade A to AH which are mesh sizes 20-30 to 170-325 or other hard abrasive particles, such as aluminum oxide (grit sizes to 12 to 400). A combination of glass beads, ceramic beads and aluminum oxide media, applied in succession, may be required to produce a surface finish like that shown in FIGS. 4a and 4b. For example, the roll surface is first processed with aluminum oxide of mixed grit sizes (2:3 ratio of 120 and 180 grits) with a 5/16″ nozzle and 65 PSI at a traverse speed of 1.5″ per minute followed by glass beads grade AC (mesh size 60-120) at 100 PSI using a ⅜″ nozzle and traverse speed of 1.5″ per minute. The standoff distance was adjusted based on the nozzle bristle lengths of the particular peening system. Choices of nozzles, pressures and traverse speeds would be dependent upon the apparatus used to peen. The percent area of coverage can range from 10% to 250% depending upon the desired surface finish.

A working roll surfaced in accordance with the above parameters may be operated at reductions between 10 to 45% (in contrast to EDT treated rolls which are typically operated at reduction of about 8% to 10%). The higher level of reduction may be utilized to eliminate one or more reduction passes that might otherwise be required to achieve a desired thickness and surface appearance. The resultant sheet has an isotropic appearance and isotropic functionality.

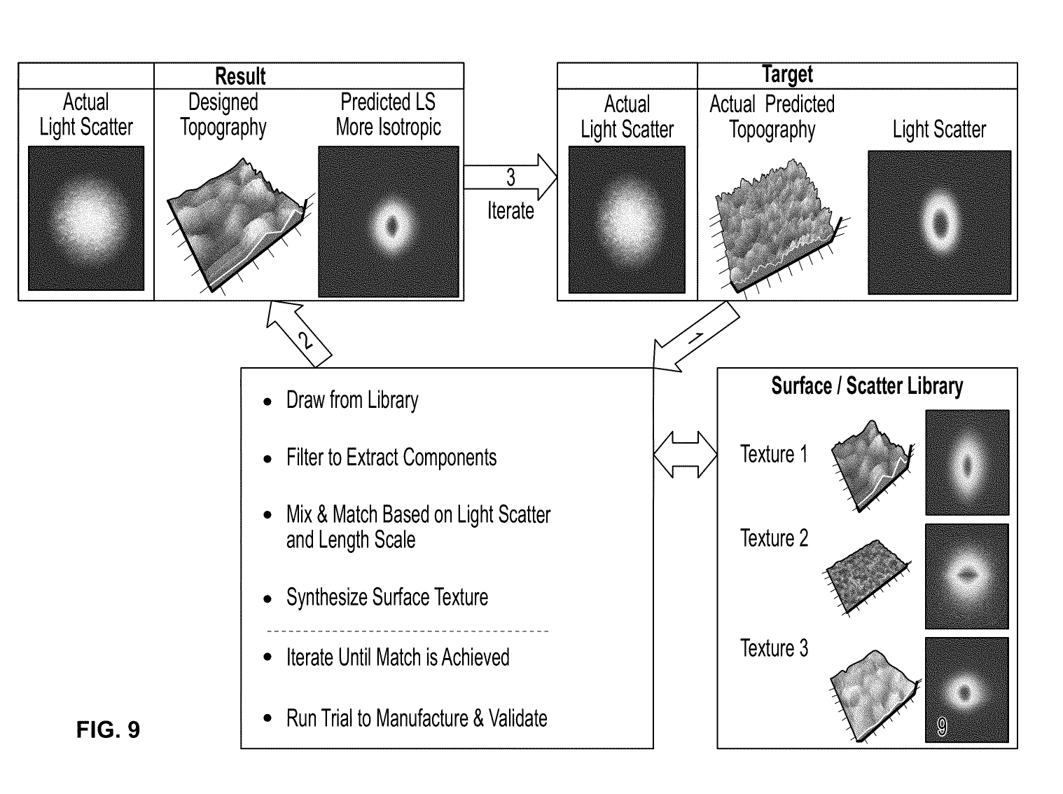

FIG. 9 shows a diagram of a process for developing a surface texture in accordance with an exemplary embodiment of the present disclosure. In a first stage (I) (not shown), the surface topologies that are obtained by using a range of peening conditions and media types are predicted. For a work roll surface treated by shot-peening, the media size, composition and peening process conditions, such as velocity and % coverage, may be selected to control the desired final texture of the roll, which is then imparted to the rolled product. The relationships between these variables (media size, composition and peening process conditions) and the surfacing results obtained may be recorded and used as a basis for predictive computer modeling at stage I for any given set of parameters to produce the roll surface texture.

In the next stage (II) (shown in FIG. 9), the light scatter and appearance for a given set of real or hypothesized surface topographies are predicted. As shown in FIG. 9, modeling may include selecting a “target” surface which has specific optical properties, such as predicted light scatter, e.g., to yield a given degree of brightness. A method for generating aluminum sheet having the desired optical properties may then be pursued by the following steps. (A) accumulating a data file which associates a plurality of given surface profiles with corresponding optical properties of each surface profile, including light scatter, length scale and surfacing treatment parameters utilized to realize each of the plurality of surfaces; (B) implicitly prescribing a virtual surface by specifying target optical properties; (C) modeling the virtual surface by retrieving data pertaining to at least one surface profile with the most similar measured or predicted optical properties as the target optical properties; (D) comparing the target optical properties to the optical properties of the at least one surface profile; (E) in the event that the comparison in step (D) does not indicate identity, then retrieving data pertaining to another surface profile in the data file that has measured or predicted optical properties that are similar to the target properties but are at variance to the target properties in an opposite respect relative to how the optical properties of the at least one given surface profile differ from the target properties; (F) sampling from the optical properties of the at least one surface profile and from another surface profile in proportion to the magnitude of their respective differences from the target properties to arrive at corrected optical properties of a corrected virtual surface and recording the composited sampled composition contributions of the at least one surface profile and the other surface profile; (G) comparing the optical properties of the corrected virtual surface to the target optical properties to ascertain the reduction in the differences there between; and then repeating the steps (E)-(G) until little or no improvement is discerned, whereupon the best virtual surface relative to the target has been ascertained.

Note that steps (C) through (G) can be executed as described or can be replaced by a non-linear least squares optimization algorithm to automate the process. To complete the process, the Modeling steps (I) and (II) are combined. Namely, by: (1) ascertaining the surfacing treatment parameters utilized to realize each of the plurality of surfaces by compositing such parameters in proportion to the contribution of optical properties of each surface profile composited in the best virtual surface thereby defining best surfacing treatment parameters; (2) conducting surfacing of a roll in accordance with the best surfacing treatment parameters; and (3) rolling the aluminum sheet with the roll surfaced at step (I). As can be seen, upon reaching a modeled solution, the shot-peening parameters associated there with may be implemented in surfacing a work roll. The actual results of implementation may be stored in the database along with the process parameters that caused them to expand the modeling capability.

It will be understood that the embodiments described herein are merely exemplary and that a person skilled in the art may make many variations and modifications without departing from the spirit and scope of the claimed subject matter. For example, some disclosure above indicated that the range of roughnesses (roll grind) that are typically applied to aluminum rolling operations covering hot and cold rolling applications span <1 μin to 50 μin and that typical work roll hardnesses for Al operations is 50 to 70 Rc. Notwithstanding, the methods and apparatus of the present disclosure could be applied to any surface finish above 50 μin and any roll hardness to achieve the same results by adjusting the peening media and peening parameters, such as pressure and dwell time to affect % coverage. All such variations and modifications are intended to be included within the scope of the present disclosure.

We claim:

1. A method for surfacing a work roll for rolling aluminum sheet, comprising the following steps:
shot-peening a surface of the work roll using media which includes spherical media.

2. The method of claim 1, wherein the spherical media used for shot-peening includes steel balls.

3. The method of claim 2, wherein the steel balls are ball bearings of grade 1000.

4. The method of claim 3, wherein the ball bearings have a diameter ≦0.125 inches and a hardness Rc≧60.

5. The method of claim 1, where the step of shot-peening is preceded by the step of pre-grinding the work roll, the step of pre-grinding imparting an initial surface texture on the work roll.

6. The method of claim 2, wherein the media includes abrasive grit.

7. The method of claim 1, wherein the media includes glass balls.

8. The method of claim 1, wherein the media includes ceramic balls.

9. A method for rolling aluminum sheet, comprising the steps of:
(A) surfacing a work roll utilized for rolling aluminum sheet by shot-peening a surface of the work roll using spherical media;
(B) installing the surfaced work roll in a rolling mill; and
(C) rolling the aluminum sheet to reduce the aluminum sheet from a given initial thickness to a selected thickness and simultaneously imparting a texture from the work roll onto the surface of the aluminum.

10. The method of claim 9, wherein the spherical media used for shot-peening includes steel balls and wherein the reduction in thickness of the aluminum sheet is ≧10% of the initial thickness.

11. The method of claim 10, wherein the reduction in thickness of the aluminum sheet is in the range of 10 to 45%.

12. The method of claim 11, further comprising the step of
(D) pre-grinding the work roll prior to step (A) of surfacing, the step of pre-grinding imparting a first surface texture on the roll, the step (A) of surfacing imparting a second surface texture on the roll at least partially over-struck on the first surface texture and incompletely eradicating the first surface texture, such that a composite surface texture is formed.

13. The method of claim 11, wherein the step (A) of shot-peening may be conducted at an adjustable pressure to control media velocity and momentum when the media impacts the roll, the media and the velocity thereof corresponding to a media impression depth, width and shape on the surface of the roll and further comprising the step (E) of adjusting the pressure at which shot-peening is conducted to achieve a given surface texture.

14. The method of claim 13, wherein the dwell time of shot-peening of the roll surface is adjustable to control the number of impacts of the media on the surface of the roll and the consequential % coverage of media impressions on the surface of the roll and further comprising the step (F) of adjusting the dweel time to achieve a given surface texture.

15. The method of claim 14, wherein the surface texture of the roll has corresponding optical characteristics relating to the interaction of the surface with light impinging on the surface of the roll and the directions in which light impinging on the roll is reflected from the surface and giving rise to the diffusiveness/specularity of the surface.

16. The method of claim 15, further comprising the steps of
(G) rolling a plurality of sheets of aluminum, the sheets differing in width and at least one variation in width being rolling a narrower sheet followed by rolling a wider sheet.

17. The method of claim 15, wherein the adjustment of the velocity of the media is determined at least partially based upon the hardness of the roll.

18. The method of claim 15, wherein the adjustment of the velocity of the media is determined at least partially by the initial surface texture of the roll prior to shot-peening.

19. A method for generating aluminum sheet having desired optical properties, comprising the following steps:
(A) accumulating a data file which associates a plurality of given surface profiles with corresponding optical properties of each surface profile, including light scatter, length scale and surfacing treatment parameters utilized to realize each of the plurality of surfaces;
(B) prescribing a virtual surface by specifying target optical properties;
(C) modeling the virtual surface by retrieving data pertaining to at least one given surface profile with the most similar optical properties as the target optical properties;
(D) comparing the target optical properties to the optical properties of the at least one given surface profile;
(E) in the event that the comparison in step (D) does not indicate identity, then retrieving data pertaining to another surface profile in the data file that has optical properties that are similar to the target properties but are at variance to the target properties in an opposite respect relative to how the optical properties of the at least one given surface profile differ from the target properties;
(F) sampling from the optical properties of the at least one given surface profile and from the another surface profile in proportion to the magnitude of their respective differences from the target properties to arrive at corrected optical properties of a corrected virtual surface and recording the composited sampled composition contributions of the at least one given surface profile and the another surface profile;
(G) comparing the optical properties of the corrected virtual surface to the target optical properties to ascertain if there has been a reduction in the differences there between; and if so, then repeating the steps (E)-(G) until no improvement is discerned, whereupon the best virtual surface relative to the target has been ascertained;
(H) ascertaining the surfacing treatment parameters utilized to realize each of the plurality of surfaces by compositing such parameters in proportion to the contribution of optical properties of each surface profile composited in the best virtual surface thereby defining best surfacing treatment parameters;
(I) conducting surfacing of a roll in accordance with the best surfacing treatment parameters; and
(J) rolling the aluminum sheet with the roll surfaced at step (I).

20. A work roll for rolling aluminum sheet metal surfaced by the method of claim 1.

21. Aluminum sheet metal having a surface texture imparted by the work roll of claim 20.
